(19) United States
(12) Patent Application Publication
(10) Pub. No.: US 2024/0205044 A1
(43) Pub. Date: Jun. 20, 2024

(54) FUNCTION RESTRICTION METHOD, FUNCTION RESTRICTION APPARATUS AND NON-TRANSITORY COMPUTER READABLE STORAGE MEDIUM

(71) Applicant: Panasonic Intellectual Property Corporation of America, Torrance, CA (US)

(72) Inventors: Kotaro Sakata, Osaka (JP); Hiroki Takeuchi, Osaka (JP); Naomi Tomiyama, Kyoto (JP); Takamichi Matsusako, Tokyo (JP); Kenta Murakami, Osaka (JP); Megumi Takemoto, Kyoto (JP)

(21) Appl. No.: 18/586,841

(22) Filed: Feb. 26, 2024

Related U.S. Application Data
(63) Continuation of application No. PCT/JP22/26293, filed on Jun. 30, 2022.

(30) Foreign Application Priority Data
Sep. 1, 2021 (JP) 2021-142312

(51) Int. Cl. H04L 12/28

(52) U.S. Cl. CPC H04L 12/2821; H04L 12/282

(57) ABSTRACT

A function restriction method includes, by a computer, acquiring user information about a user for an establishment provided with a device or equipment, the user information including a level of cognitive faculty of the user, determining a restriction item to a function of the device or the equipment provided in the establishment with reference to a rule that restricts the function of the device or the equipment according to the level of the user, and outputting information indicative of the restriction item.

### FIELD OF INVENTION

The present disclosure relates to a technology for restricting a function of a device or equipment.

### BACKGROUND ART

There has been conventionally known a technology of estimating a condition of a user existing in an establishment on the basis of information acquired from a sensor provided in the establishment, and controlling a device or equipment provided in the establishment on the basis of the condition of the user. As an example of the technology, Patent Literature 1 discloses recommending a control for a device using an estimated condition of a user and an environment determination model, and instructing the device to execute the recommended control.

However, Patent Literature 1 fails to consider restricting a function of a device or equipment according to a level of cognitive faculty of a user.

Patent Literature 1: Japanese Unexamined Patent Publication No. 2019-220867

### SUMMARY OF THE INVENTION

The present disclosure has been worked out in order to solve the problem described above, and an object thereof is to present an information output method, information output apparatus and non-transitory computer readable storage medium which can restrict a function of a device or equipment according to a level of cognitive faculty of a user.

A function restriction method according to an aspect of the present disclosure includes, by a computer, acquiring user information about a user for an establishment provided with a device or equipment, the user information including a level of cognitive faculty of the user, determining a restriction item to a function of the device or the equipment provided in the establishment with reference to a rule that restricts the function of the device or the equipment according to the level of the user, and outputting information indicative of the restriction item.

### BRIEF DESCRIPTION OF THE DRAWINGS

FIG. 1 is a diagram showing an exemplary general configuration of a function control system according to an embodiment of the present disclosure.

FIG. 2 is a block diagram showing a configuration of an exemplary information processing apparatus.

FIG. 3 is a table showing data structure of exemplary device information about a device and equipment.

FIG. 4 is a table showing data structure of exemplary user information.

FIG. 5 is a table showing data structure of exemplary restrictive rule information.

FIG. 6 is a flowchart showing an exemplary function restriction process.

FIG. 7 is a table showing exemplary function restriction items determined according to a level of cognitive faculty of the user.

FIG. 8 is a flowchart showing an exemplary updating process of a level of cognitive faculty.

FIG. 9 is a table showing data structure of an exemplary level decision table.

### DETAILED DESCRIPTION

### Circumstances that Led to the Present Disclosure

As described above, a technology of controlling a device and equipment provided in an establishment on the basis of a condition of a user present in the establishment has been conventionally known. As an example of the technology, Patent Literature 1 discloses recommending a control for a device using an estimated condition of a user and an environment determination model, and instructing the device to execute the recommended control.

However, Patent Literature 1 fails to consider restricting a function of a device or equipment according to a level of cognitive faculty of a user. The cognitive faculty of a user is a generic term for an intellectual faculty of the user such as comprehension, judgement, memorization, and learning. Therefore, for example, while a remote conference is in progress in a room of a dwelling, a child having a low level of cognitive faculty is liable to enter the room using a function of opening a door of the room and impede the progress of the conference.

Accordingly, the present inventors have intensively studied a technology of restricting a function of a device or equipment according to a level of cognitive faculty of a user. As a result, the present inventors have achieved each configuration of the present disclosure described below.

(1) A function restriction method according to an aspect of the present disclosure includes, by a computer, acquiring user information about a user for an establishment provided with a device or equipment, the user information including a level of cognitive faculty of the user, determining a restriction item to a function of the device or the equipment provided in the establishment with reference to a rule that restricts the function of the device or the equipment according to the level of the user; and outputting information indicative of the restriction item.

In this configuration, information indicative of a restriction item to a function of a device or equipment provided in an establishment is output, the restriction item having been determined with reference to a rule that restricts the function of the device or the equipment according to a level of cognitive faculty of a user in the establishment. Therefore, a function of a device or equipment provided in an establishment can be restricted according to the level of cognitive faculty of the user in the establishment by restricting the function of the device or equipment provided in the establishment in accordance with the restriction item.

(2) In the function restriction method mentioned in (1), in the establishment which is divided into a plurality of spaces, it may be appreciated to further specify a space that is currently used or is scheduled to be used among the spaces as a space under restriction, and determine, in the determination of the restriction item, a restriction item to a function of a device or equipment provided in the space under restriction.

This configuration makes it possible to restrict the function of the device or equipment provided in the space that is currently used or is scheduled to be used among the plurality of spaces in the establishment.

(3) In the function restriction method mentioned in (2), it may be appreciated to further specify a first user who is currently using or is scheduled to use the establishment and a second user different from the first user among a plurality of users for the establishment, to specify, in the specification of the space under restriction, a space that the first user is currently using or is scheduled to use among the spaces as the space under restriction, to acquire, in the acquisition of the user information, user information about the second user, and to determine, in the determination of the restriction item, a restriction item to a function of a device or equipment provided in the space under restriction with reference to a rule that restricts the function of the device or the equipment according to a level of the second user.

In this configuration, the function of the device or equipment provided in the space that the first user is currently using or is scheduled to use among the spaces in the establishment is restricted according to the level of cognitive faculty of the second user different from the first user.

This can keep the second user from using a function restricted according to the level of cognitive faculty of the second user when the first user is performing or performs a function not restricted according to the level of cognitive faculty of the second user in the space that the first user is currently using or is scheduled to use.

(4) In the function restriction method mentioned in (3), it may be appreciated that the user information includes a class into which each of the users is classified, in the specification of the first user, one or more users existing in the establishment are detected, user information about each of the one or more users is acquired, and the user designated by the user information indicative of a predetermined class is specified as the first user.

In this configuration, one or more users existing in the establishment are detected, and user information about each of the one or more users is acquired. Next, the user indicated by the user information including the predetermined class is specified as the first user. Therefore, according to this configuration, the space that is currently used or is scheduled to be used by the first user existing in the establishment and being classified into the predetermined class can be specified as the space under restriction to the function of the device or equipment.

(5) In the function restriction method mentioned in (3), it may be appreciated that the user information includes a class into which each of the users is classified, in the specification of the first user, user information about each of the users is acquired, and the user designated by the user information indicative of a predetermined class is specified as the first user.

In this configuration, the user indicated by the user information including the predetermined class is specified as the first user. Therefore, in this configuration, a space that is currently used or is scheduled to be used by the first user classified into the predetermined class can be specified as the space under restriction to the function of the device or equipment.

(6) In the function restriction method mentioned in (4) or (5), an input of the predetermined class may be further received.

In this configuration, the user indicated by the user information including the predetermined input class is specified as the first user. Therefore, the space under restriction to the function of the device or equipment can be suitably changed by properly changing the predetermined class to be input.

(7) In the function restriction method mentioned in (3), the first user may be specified on the basis of an input instruction to designate the first user.

In this configuration, the first user is specified on the basis of the input instruction to designate the first user. Therefore, the space under restriction to the function of the device or equipment can be suitably changed by properly changing the first user to be designated.

(8) In the function restriction method mentioned in any one of (4) to (7), it may be appreciated that the user information includes a class into which each of the users is classified, and in the specification of the second user, user information about each of the users is acquired, and a user designated by user information indicative of a different class from the user information about the first user is specified as the second user.

In this configuration, the user indicated by user information including the different class from the user information about the first user is specified as the second user. Therefore, in this configuration, the function of the device or equipment provided in the space that is currently used or is scheduled to be used by the first user can be restricted according to the level of cognitive faculty of the second user classified into the different class from the first user.

This can keep the second user from using a function restricted according to the level of cognitive faculty of the second user when the first user is performing or performs the function not restricted according to its own class in the space that the first user is currently using or is scheduled to use.

(9) In the function restriction method mentioned in any one of (2) to (8), it may be appreciated that, in the specification of the space under restriction, schedule information indicative of use schedule of the spaces is acquired, and the space under restriction is specified on the basis of the schedule information.

In this configuration, the space to be placed under restriction to the function of the device or equipment can be properly designated on the basis of schedule information indicative of use schedule of the spaces.

(10) In the function restriction method mentioned in any one of (2) to (8), it may be appreciated that, in the specification of the space under restriction, users existing in the spaces are respectively detected, and the space under restriction is specified on the basis of a result of the user detection.

In this configuration, the space to be placed under restriction to the function of the device or equipment can be properly specified on the basis of a result of detection of the users existing in each of the spaces.

(11) The function restriction method mentioned in (1) may be appreciated to further include acquiring action information about an action of the user, judging on the basis of the action information whether the level of the user has changed to a level different from the current level, and updating, when the user is judged to have changed to the level different from the current level, the level included in the user information about the user is updated to the different level.

In this configuration, the level of cognitive faculty of the user in the establishment included in the user information about the user can be properly updated on the basis of action information about the action of the user.

(12) In the function restriction method mentioned in (11), the action information may include at least one of an attribute, a location, a voice, and an image of the user.

In this configuration, the level of cognitive faculty of the user in the establishment included in user information about the user can be properly updated on the basis of at least one of an attribute, a location, a voice, and an image of the user.

(13) A function restriction apparatus according to another aspect of the present disclosure includes an acquisition part that acquires user information about a user for an establishment provided with a device or equipment, the user information including a level of cognitive faculty of the user, a determination part that determines a restriction item to a function of the device or the equipment provided in the establishment with reference to a rule that restricts the function of the device or the equipment according to the level of the user, and an output part that outputs information indicative of the restriction item.

In this configuration, the same advantageous effects as the function restriction method described above can be obtained.

(14) A non-transitory computer readable storage medium according to a still another aspect of the present disclosure is a non-transitory computer readable storage medium storing a program causes a computer to function as an acquisition part that acquires user information about a user for an establishment provided with a device or equipment, the user information including a level of cognitive faculty of the user, a determination part that determines a restriction item to a function of the device or the equipment provided in the establishment with reference to a rule that restricts the function of the device or the equipment according to the level of the user, and an output part that outputs information indicative of the restriction item.

In this configuration, the same advantageous effects as the function restriction method described above can be obtained.

The present disclosure may be implemented also as a system which operates in accordance with the program. It is needless to say that the computer program may be distributed via a computer-readable non-transitory recording medium such as a CD-ROM or a communication network such as Internet.

In addition, each of the embodiments described below shows a specific example of the present disclosure. The numerical values, shapes, constituent elements, steps, order of steps, and the like shown in the following embodiments are merely examples, and are not intended to delimit the present disclosure. Also, among the constituent elements in the following embodiments, constituent elements not recited in the independent claims representing the broadest concepts are described as optional constituent elements. In all the embodiments, the respective contents may also be combined.

### Embodiment

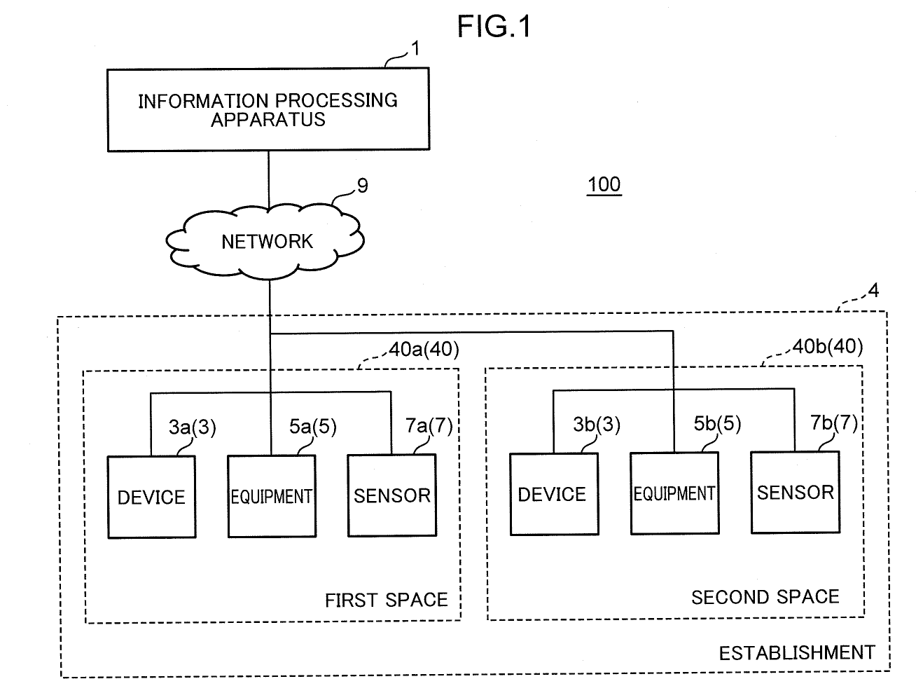

Hereinafter, an embodiment of the present disclosure will be described with reference to the drawings. FIG. 1 is a diagram showing an exemplary general configuration of a function control system 100 according to an embodiment of the present disclosure. The function control system 100 includes a plurality of devices 3, equipment 5, and sensors 7 provided in an establishment 4, and an information processing apparatus (an exemplary function restriction apparatus) 1.

The devices 3, the equipment 5, the sensors 7, and the information processing apparatus 1 are mutually communicably connected via a network 9. The network 9 includes, for example, a public communication network such as Internet. The network 9 may include Local Area Network. The devices 3, the equipment 5, and the sensors 7 may be mutually communicably connected via a local network in the establishment 4.

The establishment 4 is divided into a plurality of spaces. Some of the spaces are provided with a plurality of devices 3, equipment 5, and sensors 7. FIG. 1 shows an example in which the establishment 4 is divided into a first space 40a and a second space 40b, the first space 40a is provided with a device 3a, equipment 5a, and a sensor 7a, and the second space 40b is provided with a device 3b, equipment 5b, and a sensor 7b. Hereinafter, in the case of generally referring to the spaces in the establishment 4, it is referred to as the space 40.

The establishment 4 is, for example, a dwelling. The dwelling may be an apartment, or may be an independent house. Alternatively, the establishment 4 may be an office. In a case where the establishment 4 is a dwelling, a user of the devices 3 and the equipment 5 is a dweller, and the space 40 is, for example, a living room, a dining room, a kitchen, an LDK (a living-dining-kitchen), a western style room, a Japanese style room, a corridor, a toilet, an entrance, a bath, or the like. The LDK is a space that is adapted for a living room, a dining room, and a kitchen. In a case where the establishment 4 is an office, a user of the devices 3 and the equipment 5 is a user of the office, and the space 40 is, for example, an office room, a conference room, an office kitchenette, a drawing room, a lobby, a corridor, a toilet, or the like. Hereinafter, a dweller and a user in the establishment 4 will be referred to as a user in the establishment 4.

The device 3 is an electronic device freely arrangeable in the establishment, such as a rice cooker, a washing machine, a refrigerator, a microwave oven, a cleaning robot, a smartphone, and a laptop computer. The device 3 has one or more functions. A function of the device 3 is accomplished by the user operating a switch incorporated in the device 3 and a remote controller. Further, the device 3 executes its function in accordance with a control instruction received from the information processing apparatus 1 via the network 9. The execution of the function of the device 3 is restricted (forbidden) in accordance with a restriction instruction received from the information processing apparatus 1 via the network 9.

The equipment 5 is an electronic apparatus such as an electronic lock, an air conditioner, a photovoltaic power apparatus or the like that is installed at a predetermined position in the establishment 4. The equipment 5 has one or more functions. A function of the equipment 5 is accomplished by the user operating a switch incorporated in the equipment 5 and a remote controller. Further, the equipment 5 executes its function in accordance with an instruction received from the information processing apparatus 1 via the network 9. The execution of the function of the equipment 5 is restricted in accordance with a restriction instruction received from the information processing apparatus 1 via the network 9.

The sensor 7 periodically detects information about the space 40 provided with the sensor 7. The sensor 7 sends information of a detection (hereinafter, detection information), information indicative of a date and a time (hereinafter, detection time and date information) when the detection information is acquired, and information (hereinafter, sensor information) including discrimination information of the sensor 7 to the information processing apparatus 1 via the network 9. The sensor 7 includes a camera, a microphone, a human sensing sensor, a radio wave sensor, and the like.

The camera captures an image of the space 40, and sends sensor information including image data indicative of the captured image as the detection information. The microphone collects sound generated in the space 40, and sends sensor information including audio data indicative of the collected sound as the detection information. The human sensing sensor detects whether a person exists in the space 40. When detecting that a person exists in the space 40, the human sensing sensor sends sensor information including information indicative of a location of the person as the detection information. The radio wave sensor detects a location and a shape of a person existing in the space 40 on the basis of an intensity of radio waves, and sends sensor information including information indicative of the detected location and shape of the person as the detection information.

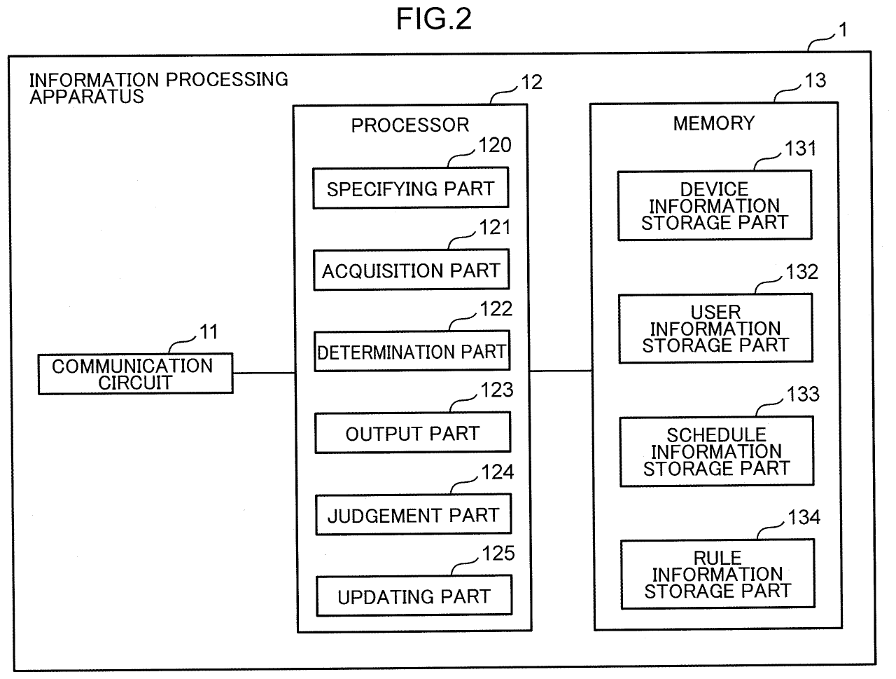

The information processing apparatus 1 includes a cloud server, a computer, and the like. The information processing apparatus 1 may use an edge server provided in the establishment 4. FIG. 2 is a block diagram showing a configuration of an exemplary information processing apparatus 1. The information processing apparatus 1 includes a communication circuit 11, a processor 12, and a memory 13.

The communication circuit 11 is a communication interface circuit adapted to a communication system by use of the network 9 such as Ethernet (trademark) and connects the information processing apparatus 1 to the network 9. The communication circuit 11 outputs various information received via the network 9 to the processor 12. Further, under the control of the processor 12, the communication circuit 11 sends various information via the network 9 to an external device connected to the network 9.

The processor (an example of the computer) 12 is composed of a CPU. The processor 12 includes a specifying part 120, an acquisition part 121, a determination part 122, an output part 123, a judgement part 124, and an updating part 125. The specifying part 120 to the updating part 125 may be embodied through an execution of a predetermined program by the processor 12, or may be made up of a dedicated hardware circuit. Details on the specifying part 120 to the updating part 125 will be described later.

The memory 13 includes a non-volatile and rewritable semiconductor memory, e.g., Flash Memory, HDD (Hard Disk Drive), SSD (Solid State Drive), and the like.

The memory 13 is composed of a storage device, e.g., hard disk drive and solid-state drive, and includes a device information storage part 131, a user information storage part 132, a schedule information storage part 133, and a rule information storage part 134.

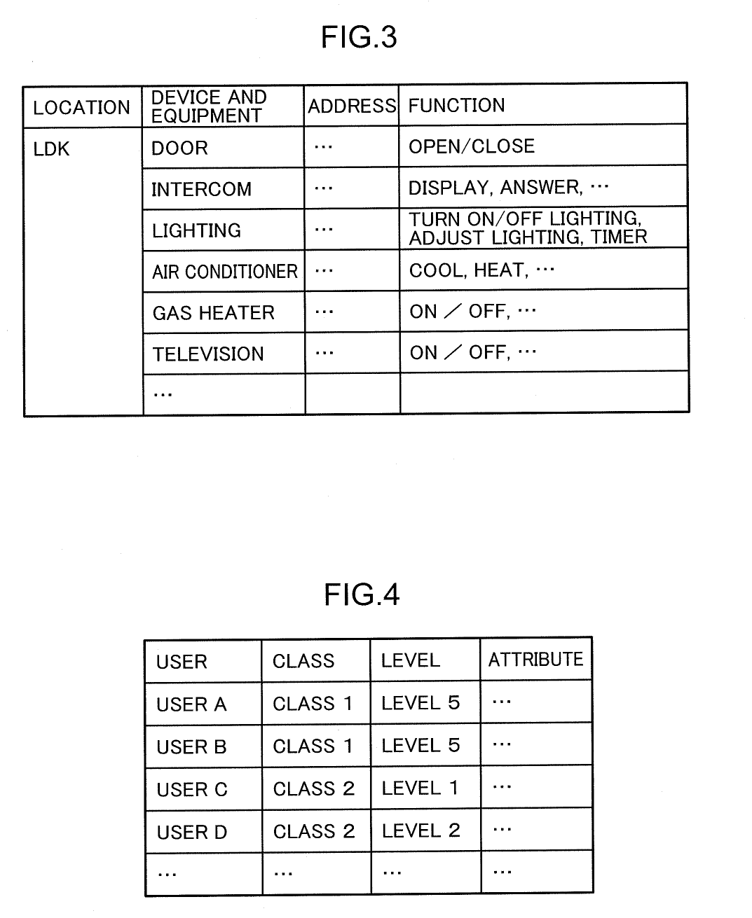

The device information storage part 131 stores information (hereinafter, device information) about the devices 3, the equipment 5, and the sensors 7 provided in the establishment 4. FIG. 3 is a table showing an exemplary data structure of device information about the devices 3 and the equipment 5. Specifically, the device information about the devices 3 and the equipment 5 includes a location of the space 40 where the devices 3 and the equipment 5 are arranged, discrimination information of the devices 3 and the equipment 5, an address indicating a destination for a control instruction transmission to the devices 3 and the equipment 5, and a function of the devices 3 and the equipment 5. The device information (not shown) about the sensor 7 includes a location of the space 40 where the sensor 7 is provided and discrimination information and the like concerning the sensor 7.

The user information storage part 132 stores information (hereinafter, user information) about each of the users of the establishment 4. FIG. 4 is a table showing an exemplary data structure of the user information. Specifically, the user information includes identification information, a class, a level, and an attribute of a user.

The class is information according to which each of the users of the establishment 4 is classified. The class includes, for example, classification of activities (e.g., work, household affairs, study, and play) mainly performed by the user, a priority order (e.g., first, second) according to which devices 3 and equipment 5 are used by the users of the establishment 4, and the like. In the case where the establishment 4 is a dwelling, a family attribute (for example, father, mother, child) of the user may be adopted as a class.

The level means a degree of cognitive faculty of the user. The cognitive faculty of the user is a generic term for intellectual faculty of the user such as comprehension, judgement, memorization, and learning. For example, a user having a high level of cognitive faculty is capable of fully understanding a situation where another user in the establishment 4 is performing a task such as household affairs, work, and study using a device 3 or equipment 5. Therefore, the user having a high level of cognitive faculty can oneself avoid the use of the function of a device 3 or equipment 5 that is liable to impede the task of the another user. In contrast, a user having a low level of cognitive faculty is liable to fail to fully understand the situation where another user in the establishment 4 is performing a task using a device 3 or equipment 5. In this case, the user having a low level of cognitive faculty is liable to use the function of a device 3 or equipment 5 that hinders an operation of the another user. In the example of FIG. 4, a greater numerical value indicates a higher degree of cognitive faculty. For example, a level “Level 5” of a user “User A” means to be higher in the cognitive faculty than a level “Level 1” of a user “User C”.

The attribute is information indicative of particulars of the user, and includes an age, a gender, and the like.

The user information storage part 132 further stores reference data that is used to collate with sensor information for the purpose of recognizing a user existing in the establishment 4, estimating an action of the user, and the like. Specifically, the reference data includes various data indicative of particulars of the user, e.g., image data indicative of a photographed image of a face or a full-length of the user and audio data indicative of a voice of the user.

The schedule information storage part 133 stores schedule information (not shown) indicative of use schedule of a space 40 in the establishment 4. Specifically, the schedule information includes discrimination information of the space 40 scheduled to be used, identification information of the user who uses the space 40, and information indicative of a period of time in which the space 40 is used.

The rule information storage part 134 stores information (hereinafter, restrictive rule information) indicative of a rule that restricts a function of a device 3 or equipment 5 according to a level of cognitive faculty of a user in the establishment 4.

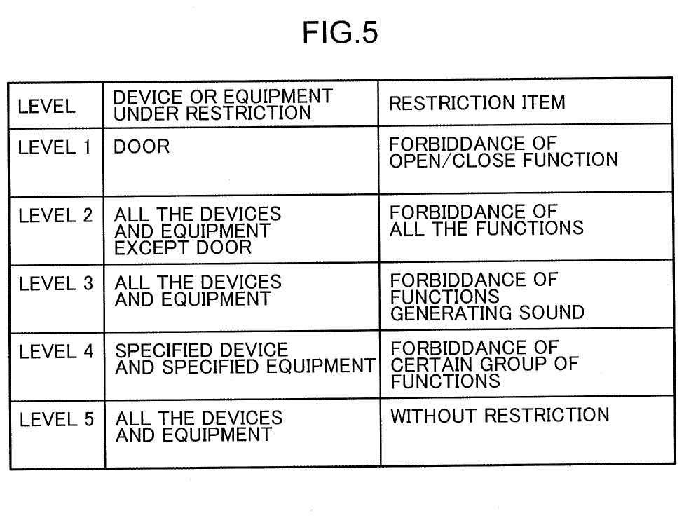

FIG. 5 is a table showing data structure of exemplary restrictive rule information. Specifically, the restrictive rule information includes a level of cognitive faculty of a user in the establishment 4, discrimination information of a device 3 or equipment 5 to be placed under restriction of a function commensurate with the level, a function restriction item under which the device 3 or the equipment 5 is placed.

The restrictive rule information in FIG. 5 indicates that, as a function restriction commensurate with “Level 1” of cognitive faculty level, an open/close function of a door is forbidden. Further, the restrictive rule information in FIG. 5 indicates that, as a function restriction commensurate with “Level 2” of the cognitive faculty level, all the functions of all the devices 3 and the equipment 5 except the door are forbidden.

Further, the restrictive rule information in FIG. 5 indicates that, as a function restriction commensurate with “Level 3” of the cognitive faculty level, all the functions of all the devices 3 and the equipment 5 that generate sounds are forbidden. The restrictive rule information in FIG. 5 indicates that, as a function restriction commensurate with “Level 4” of the cognitive faculty level, a certain group of functions of specified device 3 and equipment 5 is forbidden. The device information storage part 131 stores information indicative of all the functions of all the devices 3 and the equipment 5 provided in the establishment 4 that generate sounds, the specified device 3 and equipment 5 provided in the establishment 4, and a certain group of functions of the specified device 3 and equipment 5.

The restrictive rule information in FIG. 5 indicates that, as a function restriction commensurate with “Level 5” of the cognitive faculty level, no function of any device 3 and equipment 5 is restricted.

The rule information storage part 134 may store a piece of rule information indicative of a rule that restricts a function of a device 3 or equipment 5 provided in each space 40 included in the establishment 4.

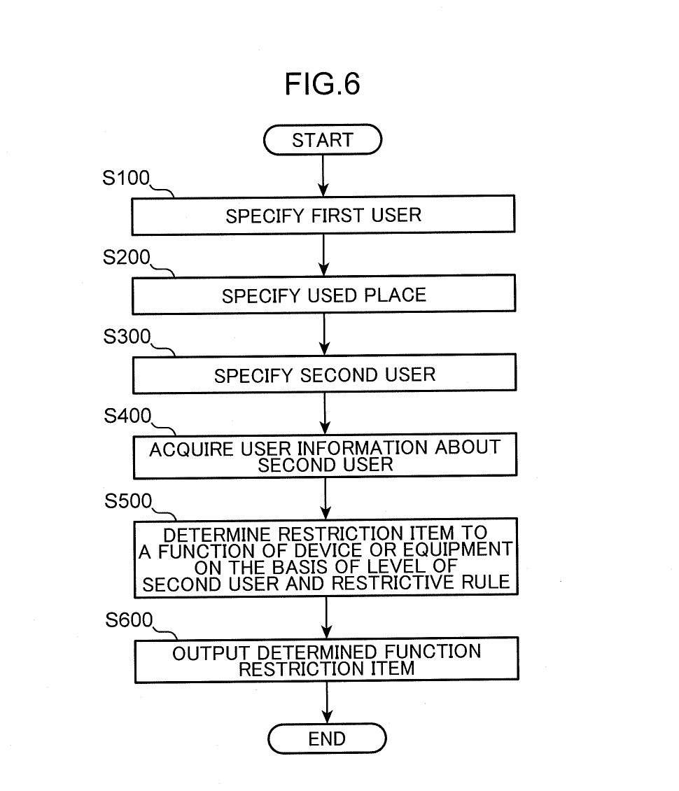

Next, a flow of a function restriction process executed in the information processing apparatus 1 will be described. The function restriction process is a process that restricts a function of the devices 3 or the equipment 5 provided in the establishment 4 according to a level of cognitive faculty of a user in the establishment 4. In the description, details on the specifying part 120 to the output part 123 will be described. FIG. 6 is a flowchart showing an exemplary function restriction process. The function restriction process is executed every predetermined time in which the use schedule of the spaces 40 is estimated to change, e.g., every 30 minutes.

First, the specifying part 120 specifies a user (hereinafter, a first user) who is currently using or is scheduled to use the establishment 4 among the users of the establishment 4 (Step S100).

Specifically, in Step S100, the specifying part 120 acquires sensor information (hereinafter, current sensor information) that includes detection time and date information indicative of current time and date having a predetermined time period and detection information indicative of the existence of a person in the space 40 from sensor information stored in the memory 13.

Further, in Step S100, the specifying part 120 collates the detection information included in the current sensor information with the reference data stored in the user information storage part 132 to thereby detect one or more users staying in the establishment 4 at the current time and date having the predetermined time period. The specifying part 120 acquires user information about each of the one or more users from the user information storage part 132. The specifying part 120 specifies a user designated by user information indicative of a predetermined first class (an example of the predetermined classes) among the acquired user information as the first user.

The first class is information corresponding to a user having the highest level of cognitive faculty in the establishment 4, e.g., father, mother, work, study, first rank, or the like, and is stored in advance in the memory 13. The specifying part 120 may receive an input of information indicative of the first class from an external device. Specifically, when the communication circuit 11 receives information indicative of the first class from an external device, the acquisition part 121 may acquire the information indicative of the first class and store the information indicative of the first class in the memory 13.

In Step S100, the specifying part 120 may acquire user information about each of all the users of the establishment 4 from the user information storage part 132. Next, the specifying part 120 may specify a user designated by the user information indicative of the predetermined first class among the acquired user information as the first user.

Alternatively, in Step S100, the specifying part 120 may specify the first user on the basis of an input instruction that designates the first user. Specifically, in a case that the communication circuit 11 receives identification information of the first user from an external device such as a smartphone used by a user in the establishment 4, the specifying part 120 may determine that an input instruction to designate the first user is entered, to thereby specify a user who is identified on the basis of the identification information as the first user.

Subsequently, the specifying part 120 specifies a space 40 (hereinafter, “use place”) that is currently used or is scheduled to be used in the establishment 4 by the first user specified in Step S100 (Step S200).

Specifically, in Step S200, the specifying part 120 collates with the schedule information stored in the schedule information storage part 133. Accordingly, the specifying part 120 specifies the space 40 that the first user specified in Step S100 is scheduled to use in a time period including the current time as the use place (an exemplary space under restriction).

In Step S200, the specifying part 120 may specify on the basis of the current sensor information a space 40 where the first user exists as the use place. Specifically, the specifying part 120 may retrieve discrimination information concerning the sensor 7 from sensor information including detection information indicative of the existence of the first user in the space 40 among current sensor information. Next, the specifying part 120 may designate on device information about the sensor 7 stored in the device information storage part 131 a space 40 provided with the sensor 7 designated by the discrimination information. Subsequently, the specifying part 120 may designate the space 40 as the use place.

Subsequently, the specifying part 120 specifies a user different from the first user (hereinafter, the second user) among the users of the establishment 4 (Step S300).

Specifically, in Step S300, the specifying part 120 specifies a second user in the same manner as the specification of the first user in Step S100. For example, the specifying part 120 acquires user information about each of all the users of the establishment 4 from the user information storage part 132. Next, the specifying part 120 specifies a user designated by the user information indicative of a predetermined second class different from the first class among the acquired user information as the second user. In a case where a plurality of users designated by user information indicative of the predetermined second class exists, the specifying part 120 specifies a user designated by user information indicative of the lowest level as the second user.

For example, information about a user having the lowest level of cognitive faculty in the establishment 4, e.g., child, infant, play, and fourth is adopted as the second class, and is stored in advance in the memory 13. The specifying part 120 may receive an input of information indicative of the second class from an external device in the same manner as the information indicative of the first class.

Alternatively, the specifying part 120 acquires the current sensor information from the memory 13, collates the detection information included in the current sensor information with the reference data stored in the user information storage part 132 to thereby detect one or more users who stays in the establishment 4 at the current time and date having the predetermined time period. Next, the specifying part 120 acquires user information about each of the one or more users from the user information storage part 132. Subsequently, the specifying part 120 specifies as the second user a user designated by the user information indicative of the predetermined second class among the acquired user information. In the case where a plurality of users designated by user information indicative of the predetermined second class exist, the specifying part 120 specifies a user designated by the user information indicative of the lowest level as the second user.

Alternatively, the specifying part 120 may specify the second user on the basis of an input instruction designating the second user. Specifically, for example, the communication circuit 11 receives identification information concerning the second user from an external device such as a smartphone used by a user in the establishment 4. In this case, the specifying part 120 determines that an input instruction designating the second user is entered, and specify a user identified by the identification information as the second user.

Next, the acquisition part 121 acquires the user information about the second user specified in Step 300 from the user information storage part 132 (Step S400).

Subsequently, the determination part 122 determines a restriction item to a function of the device 3 or equipment 5 provided in the use place specified in Step S200 on the basis of the level of cognitive faculty of the second user specified in Step S300 and the restrictive rule information stored in the rule information storage part 134 (Step S500).

Specifically, in Step S500, the determination part 122 collates with the level of cognitive faculty of the second user included in the user information about the second user acquired in Step S400. Further, the determination part 122 acquires the restrictive rule information stored in the rule information storage part 134. In a case that the rule information storage part 134 stores restrictive rule information indicative of a restrictive rule to a function of a device 3 or equipment 5 provided in each space 40 as described above, in Step S500, the determination part 122 acquires the restrictive rule information that is stored in the rule information storage part 134 and is associated with the use place specified in Step S200.

Next, the determination part 122 retrieves, from the acquired restrictive rule information (e.g., FIG. 5), discrimination information (e.g., “door”) and a restriction item (e.g., “forbiddance of open/close function”) to a function of the device 3 or equipment 5 provided in the use place that is associated with the level (e.g., “Level 1”) of cognitive faculty of the second user. Thereafter, the determination part 122 determines the acquired restriction item as a restriction item to a function of the device 3 or equipment 5 that is provided in the use place specified in Step S200 and is discriminated on the basis of the acquired discrimination information.

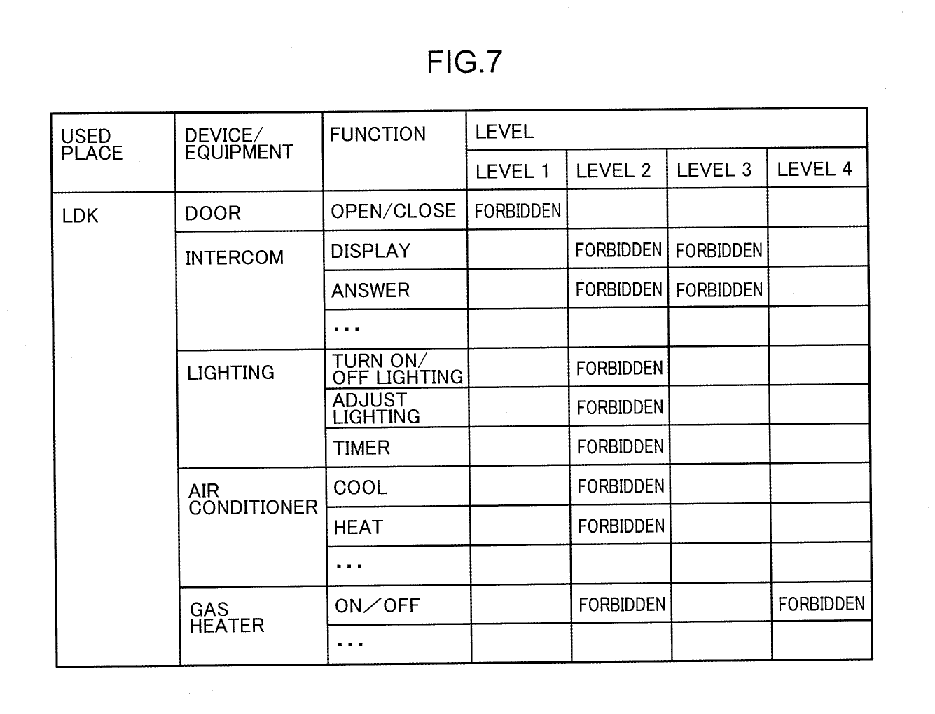

FIG. 7 is a table showing exemplary function restriction items to be determined according to a level of cognitive faculty of the user. FIG. 7 shows an example where the use place is specified to be “LDK (Living Dining Kitchen)”, and a restriction item to a function of each of five device 3 or equipment 5 provided in the use place “LDK” is determined by the determination part 122 according to a level of cognitive faculty of the second user.

For example, in a case where the second user has “Level 1” of the cognitive faculty level, the determination part 122 collates with the restrictive rule information shown in FIG. 5 to determine the forbiddance of the open/close function of the door. In a case where the second user has “Level 2” of the cognitive faculty level, the determination part 122 collates with the restrictive rule information shown in FIG. 5 to determine the forbiddance of all the functions of all the devices 3 and equipment 5 except the door provided in the use place “LDK”.

In a case where the second user has “Level 3” of the cognitive faculty level, the determination part 122 collates with the restrictive rule information shown in FIG. 5, and information that is stored in the device information storage part 131 and concerns sound generation functions of all the devices 3 and equipment 5 provided in the establishment 4. Thereafter, the determination part 122 determines the forbiddance of execution of a display function and an answer function of an intercom that has the sound generation function among all the devices 3 and equipment 5 provided in the use place “LDK”.

In a case where the second user has “Level 4” of the cognitive faculty level, the determination part 122 collates with the restrictive rule information shown in FIG. 5. Further, the determination part 122 collates with information that is stored in the device information storage part 131 and concerns specified device 3 and equipment 5 provided in the establishment 4, and information that concerns a certain function of the specified device 3 and equipment 5. Thereafter, the determination part 122 determines the forbiddance of execution of an ON/OFF function of a gas heater that is the specified function among the specified devices 3 and equipment 5 provided in the use place “LDK”.

In a case where the second user has “Level 5” of the cognitive faculty level, the determination part 122 collates with the restrictive rule information shown in FIG. 5, and determines not to forbid any function of any device 3 and equipment 5 provided in the use place “LDK”.

After the step S500, the output part 123 outputs information indicative of the restriction item to a function of the device 3 and equipment 5 provided in the use place specified in Step S500 (Step S600).

Specifically, in Step S600, the output part 123 collates with device information concerning the use place specified in Step S200 as the location and the discrimination information of the device 3 or equipment 5 acquired in Step S500 among the device information stored in the device information storage part 131. The output part 123 sends, using the communication circuit 11, a restriction instruction concerning a restriction to the execution of a function in accordance with the restriction item determined in Step S500 to an address associated with the discrimination information of the device 3 or equipment 5 that is included in the device information and is acquired in Step S500.

Consequently, in response to the received restriction instruction, the device 3 or equipment 5 in the use place that is discriminated on the basis of the discrimination information acquired in Step S500 is placed under the function restriction in accordance with the restriction item determined in Step S500. This is how, in this configuration, the function of the device 3 or equipment 5 provided in the use place that is currently used or is scheduled to be used by the first user can be restricted according to a level of cognitive faculty of the second user in the establishment 4.

Step S100 may be omitted. In this case, in Step S200, the specifying part 120 may specify a use place on the basis of schedule information stored in the schedule information storage part 133. Specifically, the determination part 122 may collate with the schedule information stored in the schedule information storage part 133 to specify a space 40 that is scheduled to be used in the time period including the current time as the use place.

Alternatively, in Step S200, the specifying part 120 may specify a use place on the basis of sensor information stored in the memory 13. Specifically, the determination part 122 may acquire the current sensor information from the memory 13, collate with device information about the sensor 7 stored in the device information storage part 131, locate a space 40 provided with the sensor 7 indicated by the discrimination information included in the current sensor information, and specify the space 40 as the use place.

### Updating Process of Level of Cognitive Faculty

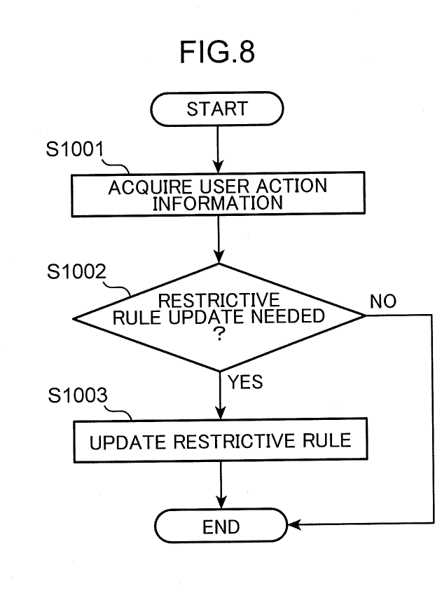

Next, the updating process of a level of cognitive faculty will be described. In the description, the judgement part 124 and the updating part 125 will be described. FIG. 8 is a flowchart showing an exemplary updating process of a level of cognitive faculty. The updating process of a level of cognitive faculty is executed at a desired time, e.g., once a month.

The acquisition part 121 acquires information (hereinafter, action information) about an action of the user in the establishment 4 (Step S1001).

Specifically, the acquisition part 121 acquires, as the action information, sensor information (hereinafter, target sensor information) including detection time and date information indicative of within a predetermined time from the recent time and detection information including at least one of a location, a voice, and an image of a person existing in the space 40 from the information stored in the memory 13.

Further, the acquisition part 121 collates the target sensor information with the reference data stored in the user information storage part 132 to thereby recognize a user staying in the establishment 4 at wihin the predetermined time from the recent time. Thereafter, the acquisition part 121 acquires user information about the user from the user information storage part 132 as the action information.

Thereafter, the judgement part 124 judges, on the basis of the action information acquired in Step S1001, whether the level of cognitive faculty of the user in the establishment 4 has changed to a level different from the current level (Step S1002).

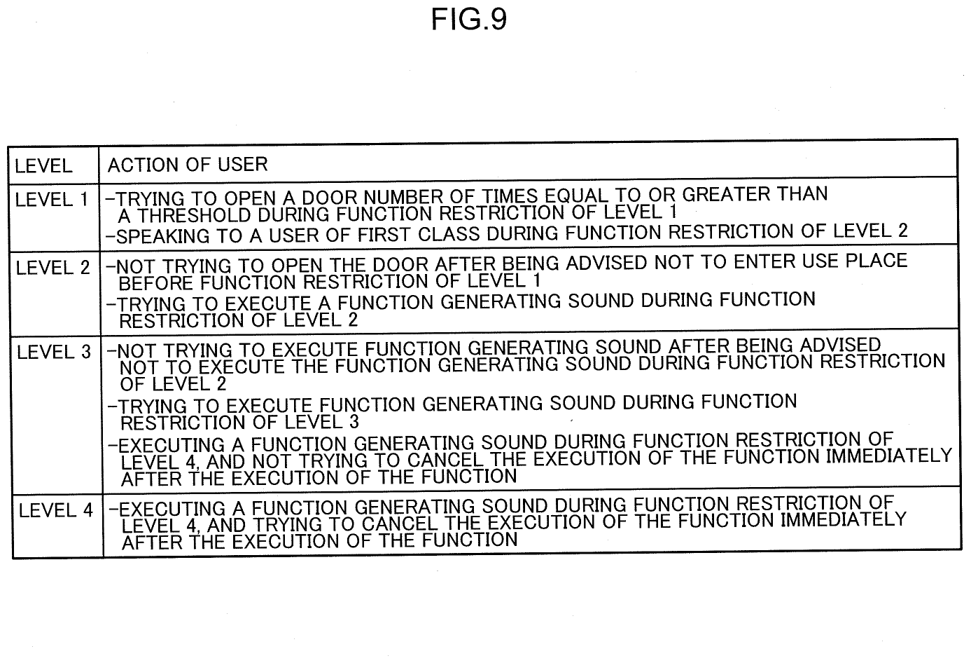

FIG. 9 is a table showing an exemplary data structure of a level decision table. Specifically, the user information storage part 132 stores a level decision table that associates a level of cognitive faculty of a user with an action of a user of the level as shown in FIG. 9.

In Step S1002, the judgement part 124 estimates an action of the user on the basis of at least one of the location, the voice, and the image of the user included in the action information acquired in Step S1001. The judgement part 124 collates with the level decision table stored in the user information storage part 132 to thereby acquire a level of cognitive faculty of the user corresponding to the estimated action of the user. In a case where the acquired level of cognitive faculty of the user is different from the level included in the user information about the user included in the action information, the judgement part 124 judges that the level of cognitive faculty of the user has changed to a level different from the current level.

In a case that the judgement part 124 estimates, on the basis of the action information acquired in Step S1001, that a user who is on “Level 1” of the cognitive faculty level and has stayed in the establishment 4 within a predetermined time from the recent time has tried to open a door times equal to or greater than a threshold during a function restriction in accordance with the “Level 1”, for example, the judgement part 124 collates with the level decision table shown in FIG. 9 to thereby judge that the level of cognitive faculty of the user has not changed because the level of cognitive faculty corresponding to the estimated action of the user is “Level 1” that is the same as the current level.

On the other hand, in a case that the judgement part 124 estimates, on the basis of the action information acquired in Step S1001, that no attempt to open the door is made by the user after being advised not to enter a use place before the function restriction according to “Level 1” starts, the judgement part 124 collates with the level decision table shown in FIG. 9 to thereby judge the level of cognitive faculty of the user has changed to a level different from the current level because the level of cognitive faculty corresponding to the estimated action of the user is “Level 2” that is different from the current level.

The user information storage part 132 may store in advance a level decision table that associates a level of cognitive faculty of a user with an attribute of a user of the level. In this case, in Step S1002, the judgement part 124 collates with the level decision table stored in the user information storage part 132 to thereby acquire a level of cognitive faculty of the user corresponding to the attribute of the user in the establishment 4 included in the action information acquired in Step S1001.

The judgement part 124 judges, on the basis of whether the acquired level of cognitive faculty of the user is different from the level included in the user information about the user included in the action information, whether the level of cognitive faculty of the user has changed to a level different from the current level.

If the level of cognitive faculty of the user is judged to have changed to a level different from the current level in Step S1002 (YES in Step S1002), the updating part 125 updates the level of cognitive faculty of the user to a level different from the current level (Step S1003).

Specifically, in Step $1003, the updating part 125 updates the level that is stored in the user information storage part 132 and is included in the user information about the user who is judged to have changed to a level of cognitive faculty different from the current level in Step S1002 to a level different from the current level.

If the judgement part 124 judges the level of cognitive faculty of the user to remain unchanged from the current level in Step S1002 (NO in Step S1002), the updating process of the level of cognitive faculty ends.

This updating process of the level of cognitive faculty can suitably update the level of cognitive faculty of the user that is included in the user information about the user in the establishment 4 on the basis of at least one of an attribute, a location, a voice, and an image of the user included in the action information.

The present disclosure may adopt the following modifications.

(1) In Step S500 (FIG. 6), the determination part 122 may detect whether a plurality of users of the first class exists in the use place specified in Step S200 (FIG. 6). It may be appreciated that if the determination part 122 detects that a plurality of users of the first class exists in the use place, the determination part 122 uses the restrictive rule information (FIG. 5) stored in the rule information storage part 134 to thereby determine a function restriction item in accordance with a level higher than the level of cognitive faculty of the second user specified in Step S300 (FIG. 6) by a predetermined level.

The detection as to whether a plurality of users of the first class exists in the use place or not may be executed as follows. Specifically, the determination part 122 collates the current sensor information stored in the memory 13 with the reference data stored in the user information storage part 132 to thereby specify one or more users existing in the use place. According to whether there are user information about two or more users including a user of the first class exists among the user information about the one or more users (FIG. 4) stored in the user information storage part 132, the determination part 122 detects whether a plurality of users of the first class exists in the use place.

In this modification, if a plurality of users of the same first class as the first user exists in the use place, the second user is allowed to execute a function restricted according to the level of cognitive faculty of the second user under oversight of different user of the first class from the first user existing in the use place. Further, in a case where the different user of the first class has a higher level of cognitive faculty than that of the second user, the different user of the first class can avoid the function restriction according to the level of cognitive faculty of the second user.

(2) In a case that the second user specified in Step S300 (FIG. 6) has the same level of cognitive faculty as the level of cognitive faculty of the first user specified in Step S100 (FIG. 6), and the schedule information stored in the schedule information storage part 133 includes a start time of the use of the use place specified in Step S200 (FIG. 6), it may be allowed to execute a function restricted according to the level of cognitive faculty only once in a predetermined time elapse from the start time of the use of the use place specified in Step S200.

Specifically, in Step S600 (FIG. 6), the output part 123 may send a control instruction that allows only once the use of a function restricted in accordance with the restriction item determined in Step S500 (FIG. 6) in a predetermined time elapse from the start time of the use of the use place specified in Step S200 (FIG. 6).

In the configuration of the modification, for example, in the case that the second user specified in Step S300 (FIG. 6) has “Level 1” of the cognitive faculty level, and the use of the open/close function of the door of the use place is determined to be forbidden in Step S500 (FIG. 6) by collating with the restrictive rule information shown in FIG. 5, the first user is allowed to execute the open/close function of the door only once at the start time of the use of the use place, and therefore can enter the use place.

Alternatively, in a case where the second user has the same level of cognitive faculty as the level of cognitive faculty of the first user, the execution of the function restriction indicated by the restriction item determined in Step S500 (FIG. 6) may be suspended until the first user exits the use place designated in Step S200 (FIG. 6). Further, the function restriction of a device 3 or equipment 5 provided in the use place may be changed to a function restriction (hereinafter, “period-limited restriction”) corresponding to a level higher than the level of cognitive faculty of the first user and the second user by a predetermined level until the first user exits the use place specified in Step S200.

Specifically, in Step S600 (FIG. 6), the output part 123 may send a control instruction that instructs a function restriction in accordance with the period-limited restriction in the use place instead of the function restriction instructed by the restriction instruction until receipt of information (hereinafter, room exit information) indicative of the exit of the first user from the use place. The period-limited restriction may be determined by the determination part 122 similarly to the Step S500 (FIG. 6) using the restrictive rule information so as to be a function restriction corresponding to a level higher than the level of cognitive faculty of the first user and the second user by a predetermined level.

The output part 123 may collate with the sensor information stored in the memory 13 to send the room exit information to the device 3 or equipment 5 to which the control instruction is sent in Step S600 (FIG. 6) when the first user staying in the use place specified in Step S200 (FIG. 6) is detected to exit the use place.

In the configuration of this modification, for example, it is assumed that the second user has “Level 1” of the cognitive faculty level, and the use of the open/close function of the door of the use place is determined to be forbidden in Step S500 (FIG. 6) by collating with the restrictive rule information shown in FIG. 5, and a control instruction is sent in Step S600 (FIG. 6) to instruct the function restriction in accordance with the restriction item corresponding to “Level 2” or “Level 3” in place of the function restriction corresponding to “Level 1” instructed by the control instruction in the use place until receipt of room exit information.

In this case, since the first user is allowed to execute the open/close function of the door in the time period in which the first user is scheduled to use the use place, the first user can enter the use place. Further, until the first user exits the use place, the execution of functions of all the devices 3 and equipment 5 except for the door can be restricted, or alternatively, the restriction to the sound generation function can be executed for all the devices 3 and equipment 5 provided in the use place.

(3) In a case where the communication circuit 11 receives additional restriction information sent to the information processing apparatus 1 owing to the operation of an external device by the first user specified in Step S100 (FIG. 6) and the additional restriction information includes information indicative of a function restriction to a device 3 or equipment 5 provided in the use place specified in Step S200 (FIG. 6), the output part 123 may send a restriction instruction that restricts the function according to the restriction item designated by the additional restriction information to the device 3 or the equipment 5 indicated by the additional restriction information.

In this modification, the first user can operate the external device to send to the information processing apparatus 1 the additional restriction information for keeping, while the first user executes a function of a device 3 or equipment 5 in the use place, another user from using a function of the device 3 or equipment 5 that would impede the execution. Therefore, the first user can smoothly execute the function of the device 3 or the equipment 5 in the use place.

(4) Step S100 and Step S200 (FIG. 6) may be omitted. Further, in Step 500 (FIG. 6), the determination part 122 may determine a restriction item to a function of a device 3 or equipment 5 provided in the establishment 4 on the basis of the level of cognitive faculty of the second user specified in Step S300 (FIG. 6) and the restrictive rule information (FIG. 5) stored in the rule information storage part 134. In this modification, the function of the device 3 or the equipment 5 provided in the establishment 4 can be restricted according to the level of cognitive faculty of the second user.

In this case, as described above, the determination part 122 may specify a use place in the same manner as the case of omitting the Step S100 (FIG. 6) and specifying the use place in Step S200 (FIG. 6) to thereby loosen the function restriction to a device 3 or equipment 5 provided in the use space.

For example, in a case where the determination part 122 collates with the restrictive rule information shown in FIG. 5 to determine a restriction item to the function of the device 3 or the equipment 5 provided in the use place in accordance with the restriction item corresponding to “Level 3”, the determination part 122 may loosen the restriction by changing the restriction item from the forbiddance of the function generating sounds to the forbiddance of the function generating sounds louder than a predetermined volume. In this case, the user who uses the use place can generate sounds smaller than the predetermined volume by the device 3 or the equipment 5 provided in the use place.

(5) The embodiment and the modifications (1) to (4) of the present disclosure may be optionally combined.

This disclosure is useful in restricting a function of a device or equipment according to a level of cognitive faculty of a user in an establishment which a plurality of users having different levels of cognitive faculty use.

1. A function restriction method, by a computer, comprising:
acquiring user information about a user for an establishment provided with a device or equipment, the user information including a level of cognitive faculty of the user;
determining a restriction item to a function of the device or the equipment provided in the establishment with reference to a rule that restricts the function of the device or the equipment according to the level of the user; and
outputting information indicative of the restriction item, wherein
the establishment is divided into a plurality of spaces,
further comprising:
specifying a space that is currently used or is scheduled to be used among the spaces as a space under restriction, wherein
in the determination of the restriction item,
a restriction item to a function of a device or equipment provided in the space under restriction is determined.

2. The function restriction method according to claim 1, further comprising:
specifying a first user who is currently using or is scheduled to use the establishment and a second user different from the first user among a plurality of users for the establishment, wherein
in the specification of the space under restriction,
a space that the first user is currently using or is scheduled to use among the spaces is specified as the space under restriction,
in the acquisition of the user information,
user information about the second user is acquired, and
in the determination of the restriction item,
a restriction item to a function of a device or equipment provided in the space under restriction is determined with reference to a rule that restricts the function of the device or the equipment according to a level of the second user.

3. The function restriction method according to claim 2, wherein
the user information includes a class into which each of the users is classified,
in the specification of the first user,
one or more users existing in the establishment are detected,
user information about each of the one or more users is acquired, and
the user designated by the user information indicative of a predetermined class is specified as the first user.

4. The function restriction method according to claim 2, wherein
the user information includes a class into which each of the users is classified,
in the specification of the first user,
user information about each of the users is acquired, and
the user designated by the user information indicative of a predetermined class is specified as the first user.

5. The function restriction method according to claim 3, further comprising:
receiving an input of the predetermined class.

6. The function restriction method according to claim 2, wherein
the first user is specified on the basis of an input instruction designating the first user.

7. The function restriction method according to claim 3, wherein
the user information includes a class into which each of the users is classified, and
in the specification of the second user,
user information about each of the users is acquired, and
a user designated by user information indicative of a different class from the user information about the first user is specified as the second user.

8. The function restriction method according to claim 1, wherein
in the specification of the space under restriction,
schedule information indicative of use schedule of the spaces is acquired, and
the space under restriction is specified on the basis of the schedule information.

9. The function restriction method according to claim 1, wherein
in the specification of the space under restriction,
users existing in the spaces are respectively detected, and
the space under restriction is specified on the basis of a result of the user detection.

10. A function restriction method, by a computer, comprising:
acquiring user information about a user for an establishment provided with a device or equipment, the user information including a level of cognitive faculty of the user;
determining a restriction item to a function of the device or the equipment provided in the establishment with reference to a rule that restricts the function of the device or the equipment according to the level of the user; and
outputting information indicative of the restriction item,
further comprising:
acquiring action information about an action of the user;
judging on the basis of the action information whether the user has changed to a level different from the current level; and
updating, when the user is judged to have changed to the level different from the current level, the level included in the user information about the user to the different level.

11. The function restriction method according to claim 10, wherein
the action information includes at least one of an attribute, a location, a voice, and an image of the user.

12. A function restriction apparatus, comprising:
an acquisition part that acquires user information about a user for an establishment provided with a device or equipment, the user information including a level of cognitive faculty of the user;
a determination part that determines a restriction item to a function of the device or the equipment provided in the establishment with reference to a rule that restricts the function of the device or the equipment according to the level of the user; and
an output part that outputs information indicative of the restriction item, wherein
the establishment is divided into a plurality of spaces,
further comprising:
a specifying part that specifies a space that is currently used or is scheduled to be used among the spaces as a space under restriction, wherein
the determination part determines a restriction item to a function of a device or equipment provided in the space under restriction.

13. A non-transitory computer readable storage medium storing a program causing a computer to function as:
an acquisition part that acquires user information about a user for an establishment provided with a device or equipment, the user information including a level of cognitive faculty of the user;
a determination part that determines a restriction item to a function of the device or the equipment provided in the establishment with reference to a rule that restricts the function of the device or the equipment according to the level of the user;
an output part that outputs information indicative of the restriction item;
the establishment being divided into a plurality of spaces, and
a specifying part that specifies a space that is currently used or is scheduled to be used among the spaces as a space under restriction, wherein
the determination part determines a restriction item to a function of a device or equipment provided in the space under restriction.
